(19) United States
(12) Patent Application Publication
(10) Pub. No.: US 2013/0341975 A1
(43) Pub. Date: Dec. 26, 2013

(54) AIRBAG ARRANGEMENT FOR SEATS ARRANGED IN TANDEM

(71) Applicants: David W. Schneider, Waterford, MI (US); Patrick Patercsak, Davisburg, MI (US); Harry Hyunho Park, Bloomfield Hills, MI (US); Chandler Macocha, Oxford, MI (US)

(72) Inventors: David W. Schneider, Waterford, MI (US); Patrick Patercsak, Davisburg, MI (US); Harry Hyunho Park, Bloomfield Hills, MI (US); Chandler Macocha, Oxford, MI (US)

(21) Appl. No.: 13/532,964

(22) Filed: Jun. 26, 2012

(51) Int. Cl. B60N 2/42; B64D 11/06; A47B 83/02; B60N 2/01

(52) U.S. Cl. 297/163; 297/216.13

(57) ABSTRACT

An airbag arrangement for protecting at least one seat occupant in an aircraft of the type having a tandem seat arrangement with a rear seat for a seat occupant and a front seat in front of the rear seat. The front seat has an airbag subassembly mounted in the seat back. The airbag subassembly has an airbag inflating between the seat back and the rear seat and uses a gas generator connected to the airbag and configured to inflate the airbag. The airbag is secured to the seat back under a cover with a tear seam and has a compacted state in which the airbag is rolled up or folded about a horizontal axis inside the seat back.

### FIELD OF THE INVENTION

The invention relates to an airbag arrangement for the protection of seat occupants in a vehicle with seats arranged in tandem, so that at least one seat is located behind another.

### BACKGROUND OF THE INVENTION

Airbags have been credited for saving lives by damping the impact of a vehicle crash on a vehicle occupant. Not only frontal impact airbags are in use, but also side impact airbags, such as side curtain airbags expanding from the roof line of a vehicle or airbags arranged in seats, a center console, or an armrest between two car seats. After the gas generator is triggered, the airbag unfolds and provides energy absorption for the seat occupant. An airbag arranged in an armrest pushes itself between the seats and between seat occupants sitting next to each other. Another known airbag design provides an airbag in the vicinity of the center tunnel of the vehicle that inflates above the heads of the vehicle occupants to protect the occupants in the event of a vehicle rollover or of an “off-side” impact.

Airbags are designed to provide a synergetic effect with seat belts that restrain seat occupants in a defined position. At least the front seats of passenger or motor vehicle and increasingly also the rear seats are provided with three-point seatbelts comprising a lap belt and a shoulder harness extending diagonally across a seat occupant's chest. The shoulder harness limits the forward excursion of a seat occupant's upper body in the event of a frontal impact.

In contrast, aircraft passenger seats are usually only equipped with a two-point seatbelt, which is a lap belt without shoulder harness. In the event of a high deceleration of an aircraft, for instance during an emergency landing or a collision, the torso of a passenger is catapulted forward absent a shoulder harness. This constitutes a potentially dangerous situation, where a forward movement may result in high head accelerations and possibly head injuries from a seat back of a seat located in front of the seat occupant.

### SUMMARY OF THE INVENTION

The object of the present invention is to provide an apparatus that improves the safety of aircraft seat occupants in the event of a high longitudinal deceleration.

According to the present invention, this object is achieved in tandem arrangements with a front seat and a rear seat for a seat occupant of the rear seat by an airbag arrangement on a rear surface of a seat back of the front seat. The front seat of the tandem arrangement may be the rear seat of a different tandem arrangement. The airbag inflates in front of the seat occupant in a direction configured to make a contact with the seat occupant's head or chest before the seat occupant contacts the seat back of the front seat during an impact sequence.

In a normal, deflated state, the airbag is stowed in a rolled or folded bundle at a location in the seat back of the front seat. Upon activation of a pyrotechnical gas generator or compressed gas source, the airbag emerges from the seat back through a horizontal tear seam and unfolds in front of the seat occupant. A preferred location on a typical aircraft seat back is below the hinge of a fold-up table and above a seat pocket of the front seat of the tandem arrangement. When the seat occupant's head and torso, due to inertia, approach the seat back of the front seat, the first contact is made with the airbag by the face or the chest of the seat occupant. Any further forward and downward movement of the seat occupant's head and upper torso is dampened by the inflated airbag that acts like a voluminous pillow. The occupant's head sinks into the airbag and avoids contact with any hard surface, or the severity of such impact can be reduced. The airbag also controls acceleration of the occupant in an effort to reduce related forces to a level below the limits of human tolerance.

The airbag has an inherent shape that expands it upward toward the head of the seat occupant.

Further details and advantages become apparent from the following description of an embodiment of the invention. The drawings are provided solely for illustrative purposes and are not intended to limit the invention to the details shown.

### BRIEF DESCRIPTION OF THE DRAWINGS

In the drawings,

FIG. 1 shows a first embodiment of an aircraft seating space with an inflated airbag and a seat occupant after a frontal impact;

FIG. 2 shows a second embodiment of an aircraft seating space with an inflated airbag and a seat occupant after a frontal impact;

FIG. 3 shows a cross-sectional view of the airbag of FIG. 1 before deployment;

FIG. 4 shows the cross-sectional view of FIG. 3 after deployment of the airbag;

FIG. 5 shows a first view of an airbag subassembly configured for the seating space of FIG. 1;

FIG. 6 shows a second view of the airbag subassembly of FIG. 5;

FIG. 7 shows a third view of the airbag subassembly of FIG. 5;

FIG. 8 shows a seat back with an enclosed airbag according to FIG. 1; and

FIG. 9 shows a top view through an opened tear seam onto an airbag mounted in a seat back according to FIG. 8.

### DETAILED DESCRIPTION OF THE INVENTION

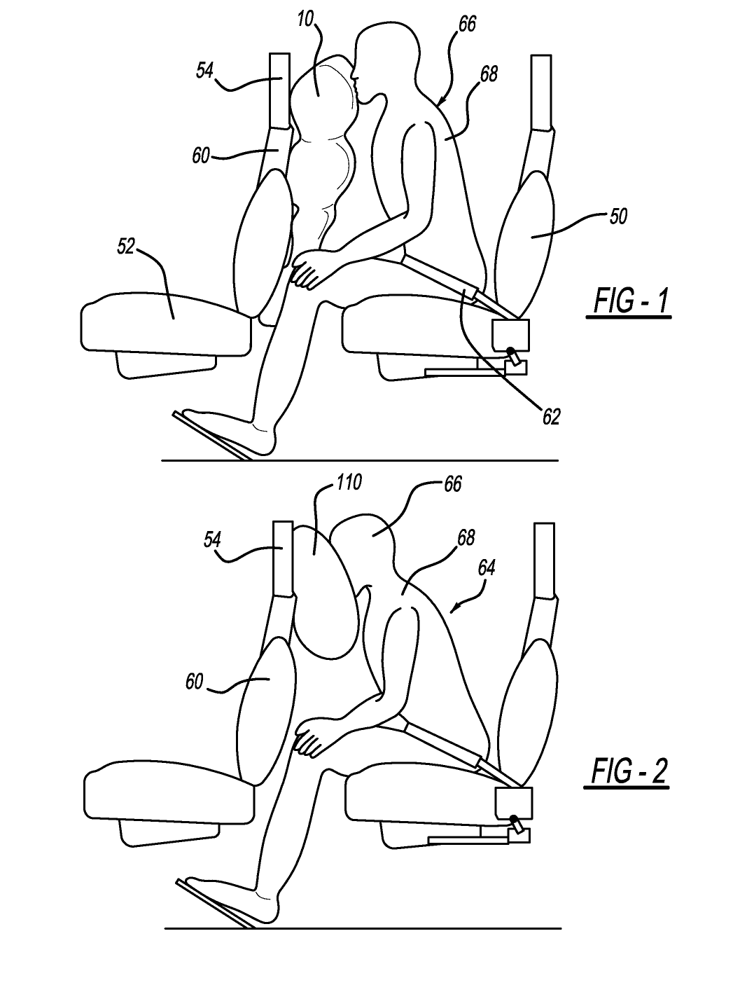

FIG. 1 shows a first aircraft seat 50 located behind a second aircraft seat 52. The seat 50 features a lap belt 62 securing a seat occupant 64 in the seat 50. After a frontal impact or large longitudinal deceleration of the aircraft, the head 66 and the upper torso 68 of the seat occupant 64 are thrown forward relative to the aircraft by inertia, causing the head 66 and upper torso 68 to move to the front and around the lap belt 62 that produces a hinging motion.

The seat back 60 of the front seat 52 includes an airbag 10 that is inflated toward the seat occupant 64 during a deceleration event before the head 66 has engaged the seat back 60. Accordingly, the head 66 contacts the inflated airbag 10 instead of continuing to move downward. The head 66 and the upper torso 68 retain an angle between each other that reduces the risk of neck injuries compared to a situation with a bare seat back 60. In the embodiment of FIG. 1, the airbag 10 is mounted in the lower half of the seat back 60 and expands upward to a height that at least partially covers a head rest portion 54 of the seat back 60.

In a second embodiment according to FIG. 2, an airbag 110 is mounted in an upper portion of the seat back 60, in or near the headrest portion 54. The airbag 110 of FIG. 2 is smaller than the airbag 10 of FIG. 1 because it inflates only at a height that corresponds to the head 66 and the upper torso 68 of the seat occupant 64.

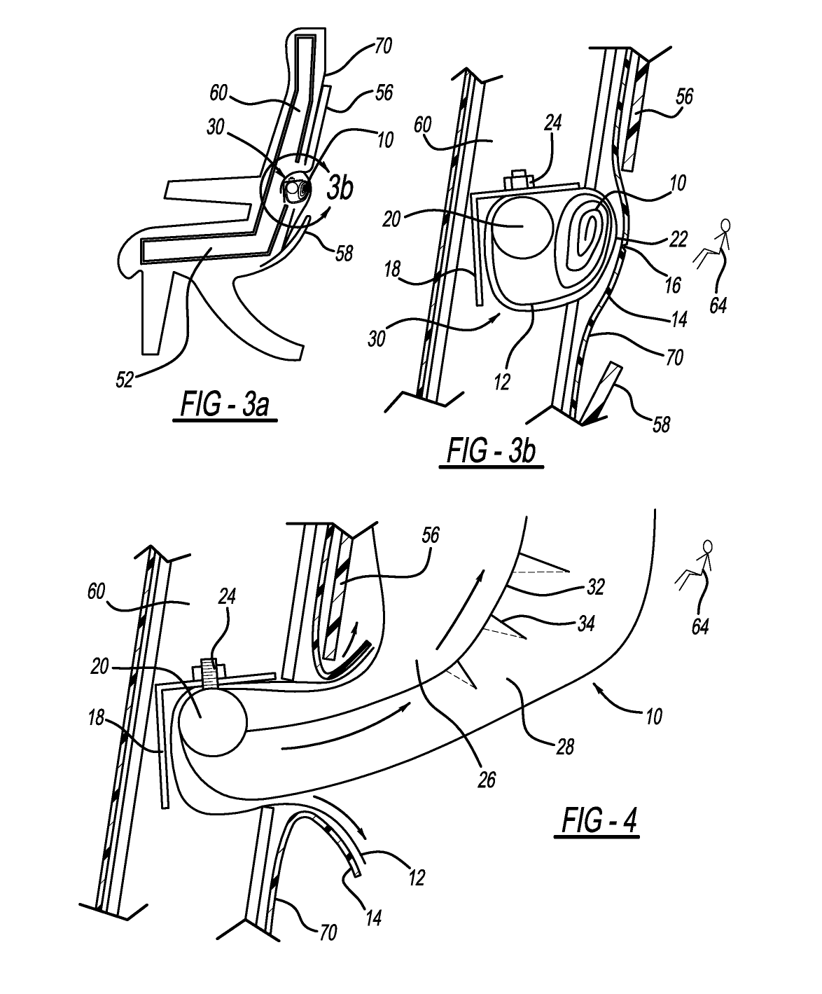

FIGS. 3a and 3b illustrate an example of a physical arrangement of the airbag 10 of FIG. 1 or of a similar device in the seat 52. FIG. 3b represents an enlarged detail view of a portion of FIG. 3a. The seat back 60 has a rear-facing, generally vertical surface 70 covered with a seat cover 14. A foldable tray table 56 is arranged adjacent to the surface 70. In the shown position, the tray table 56 is folded up and extends generally parallel to the surface 70. Below the tray table 56, a seat pocket 58 extends generally along the surface 70. Between the tray table 56 and the seat pocket 58, the seat cover 14 has a horizontal tear seam 16. An airbag subassembly 30 is mounted in the seat back 60 and hidden behind the seat cover 14 proximate the tear seam 16

The airbag subassembly 30 comprises the airbag 10, an airbag wrapper 12, a mounting bracket 18, and a gas generator 20. While a pyrotechnical gas generator is depicted in the drawings, the term gas generator is intended to include any device suitable for inflating the airbag. The airbag 10 is in a compacted state, in which it is rolled up about a horizontal axis Y (see FIG. 6). In the embodiment shown, the airbag 10 is rolled in an orientation that points upward on the side facing the seat occupant 64 and downward on the opposite side. It may also be folded along fold lines extending parallel to the horizontal axis Y. The gas generator 20 has a substantially cylindrical shape with the cylindrical axis extending generally parallel to the horizontal axis Y. The wrapper 12 surrounds both the gas generator 20 and the rolled up airbag 10. Proximate the height of the tear seam 16, the wrapper 12 has a perforation 22 or a tear seam, configured to tear open upon inflation of the airbag 10.

The mounting bracket 18 has a profile shaped like an inverted L in the shown vertical cross-section. It flanks the top of the gas generator 20 and the side of the gas generator remote from the seat occupant 64. A subassembly fastener 24 secures the gas generator 20 along with the wrapper 12 and the airbag 10 to the mounting bracket 18. In the shown embodiment, two of threaded bolts extend from the gas generator 20 and are fastened with corresponding threaded nuts.

If the gas generator 20 is triggered and inflates the airbag 10, the resulting force exerted by the airbag 10 on the wrapper 12 and on the seat cover 14 tears the perforation 22 of the wrapper 12 and the tear seam 16 of the seat cover 14 as shown in FIG. 4. During the inflation, the airbag 10 unrolls to extend toward the seat occupant 64 and upward.

In one embodiment, the airbag 10 may have an inherent shape that causes it to extend upward along the surface 70 rather than toward the seat occupant 64. The airbag 10 is assembled from a top panel 26 and a bottom panel 28. The top panel 26 and the bottom panel 28 are named after their position in the area where the airbag 10 exits the seat back 60. The top panel 26 may, for example be a planar piece of airbag fabric, while the bottom panel 28 may be made from a piece of airbag fabric that is larger than the top panel 26, at least in the direction perpendicular to the axis Y. In order to fit the edges of the bottom panel 28 with the edges of the top panel along a connecting seam 32, the bottom panel may have folds 34 or darts reducing the length of the edge of the bottom panel 28. Due to the greater length of the bottom panel, the airbag inflates into a bent cross-section as illustrated in FIG. 4.

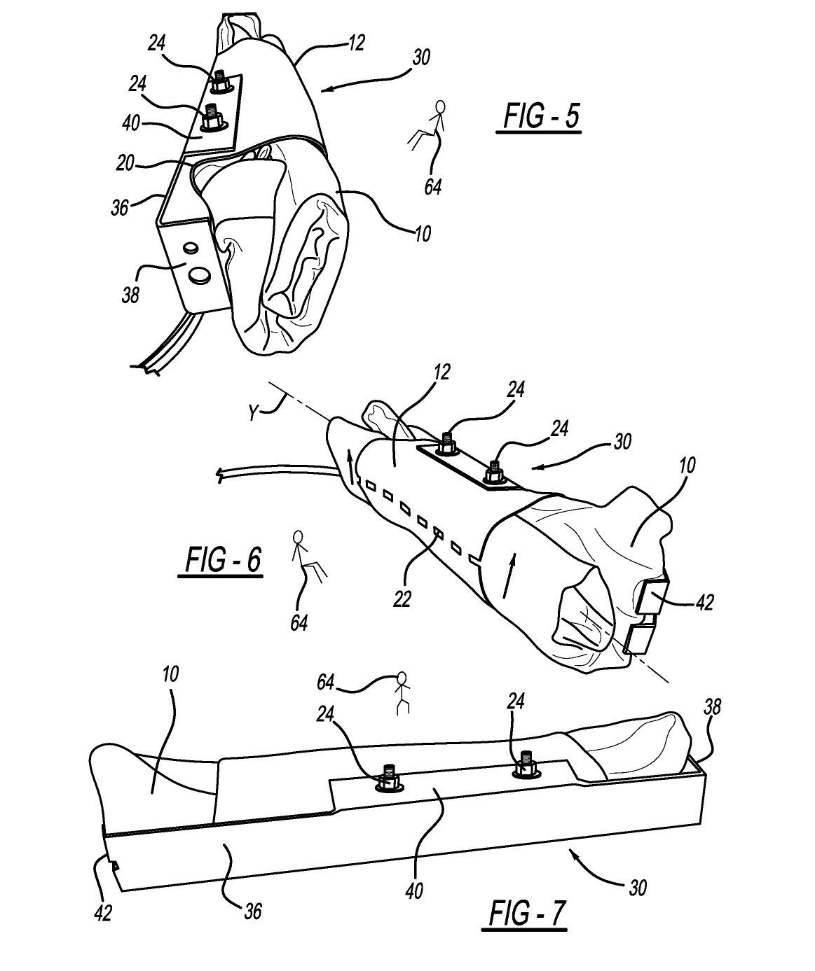

FIGS. 5, 6, and 7 show the airbag subassembly 30 in greater detail from different perspectives and will be described by the following in a synopsis. In each of the FIGS. 5, 6, and 7, a stick figure indicates the position of the seat occupant 64 relative to the airbag assembly after installation in the seat back 60.

The rolled airbag 10 and the gas generator 20 are wrapped into the wrapper 12 that extends around at least a portion of the width of airbag 10. The airbag 10, the wrapper 12, and the gas generator 20 form the subassembly 30 that is preassembled before installation in the seat back 60. In FIG. 6, the perforation 22 is visible that weakens the wrapper along a horizontal tear line that generally extends at the same height as the tear seam 16 in the seat cover 14.

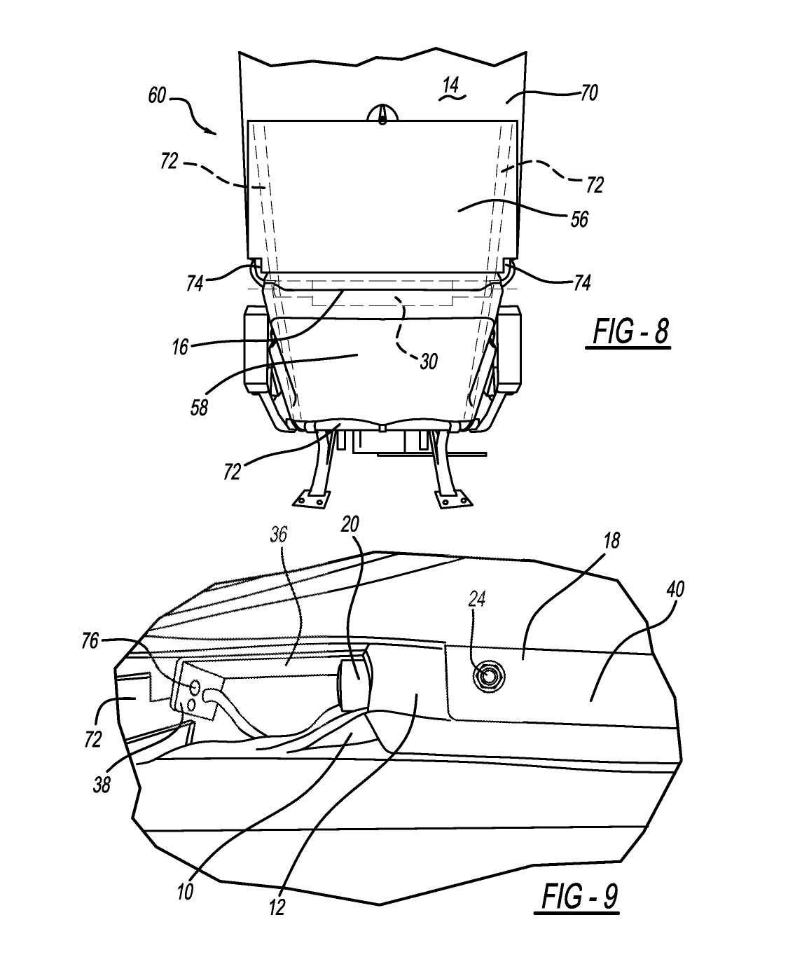

The L-shaped profile shown in FIGS. 3 and 4 is formed by a rail 36 extending in the horizontal direction in a vertical plane. Three tabs 38, 40, and 42 extend from the rail 36. Tab 40 extends centrally from the top of rail 36 in a horizontal direction toward the seat occupant 64. Two fastening bolts extending from the gas generator and two threaded nuts form the subassembly fasteners 24 that attach the gas generator 20, the wrapper 12, and the airbag 10 to the tab 40. Tabs 38 and 42 extend from the sides of rail 36 at a right angle toward the seat occupant 64 and form flanges for fastening the subassembly 30 to a seat frame 72 (shown in FIG. 8). One of the tabs 38 and 42 has a slot for easier placement inside the seat back 60.

FIG. 8 illustrates a view onto the surface 70 of the seat back 60. Broken lines indicate elements hidden behind the seat cover 14. The tray table 56 has two hinge arms 74 on laterally opposite sides. The hinge arms 74 are hingeably secured with frame fasteners 76 (FIG. 9) to two vertical struts of the seat frame 72.

The seat pocket 58 is arranged below the tray table 56. Between the tray table 56 and the seat pocket 58 extends a gap where the seat cover 14 is visible. the tear seam 16 extends laterally across the gap. Behind the tear seam 16, the airbag subassembly 30 is mounted inside the seat back 60 in a position where the perforation 22 of the wrapper extends in close vicinity of the tear seam 16. The rail 36 of the mounting bracket 18 connects the two vertical struts of the seat frame 72. The tabs 38 and 42 are secured to the seat frame 72 with the same frame fasteners 76 that secure the hinge arms 74. The frame fasteners 76 may be threaded bolts and nuts or other suitable fasteners.

FIG. 9 shows a top view onto the airbag subassembly 30 after opening the tear seam. Visible are the subassembly 30, and the frame fasteners 76. The wrapper 12 extends beyond the tab 40. The gas generator 20 and the airbag 10 emerge sideways from the wrapper 12. The subassembly fasteners 24 at the top of the subassembly 30 attach the gas generator 20 to the tab 40 of the mounting bracket 18. Tab 38 of the mounting bracket 18 is secured to the vertical strut of seat frame 72 with frame fastener 76. On the other side of the strut, opposite the tab 38, one of the hinge arms 74 (not visible) of the tray table 56 is also secured with the same frame fastener 76.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An airbag arrangement for protecting at least one seat occupant in an aircraft of the type having a tandem seat arrangement with a rear seat for a seat occupant and a front seat in front of the rear seat, the front seat having a seat back and a foldable tray table, and the rear seat facing the seat back of the front seat, the airbag arrangement comprising:
the seat back of the front seat, and
an airbag subassembly mounted in the seat back of the front seat, the airbag subassembly comprising
an airbag configured to inflate from below the foldable tray table between the seat back and the rear seat and having an inherent shape that promotes an upward movement of the airbag during inflation, the airbag having a top panel with a top panel edge and a bottom panel with a bottom panel edge, the bottom panel being made from a piece of material that is larger than the top panel and has folds or darts aligning the bottom panel edge with the top panel edge; and
at least one gas generator connected to the airbag and configured to inflate the airbag.

2. The airbag arrangement of claim 1, wherein the airbag is secured to the seat back under a cover with a tear seam.

3. The airbag arrangement of claim 1, wherein the airbag has a compacted state in which the airbag is rolled up or folded about a horizontal axis inside the seat back.

4. The airbag arrangement of claim 1, wherein the seat back comprises a seat pocket below the tray table, the airbag being secured to the seat back at a height between the seat pocket and the foldable tray table.

5. The airbag arrangement of claim 1, wherein the seat back comprises a seat frame, wherein the foldable tray table is secured to the seat frame with two hinge arms via hinge fasteners, and wherein the airbag subassembly further comprises a mounting bracket extending horizontally across the airbag subassembly, the mounting bracket being secured to the seat frame via the hinge fasteners.

6. (canceled)

7. The airbag arrangement of claim 1, wherein the airbag is secured to the seat back at a height corresponding to a chest or head height of an average seat occupant.
